(19) United States
(12) Patent Application Publication
(10) Pub. No.: US 2025/0227329 A1
(43) Pub. Date: Jul. 10, 2025

(54) MEDIA AI AGENT FOR A DIGITAL CONTENT CONTROLLER

(71) Applicant: Black Wave Adventures, LLC, Rochester, MI (US)

(72) Inventor: Daniel B. Cobb, Rochester, MI (US)

(73) Assignee: Black Wave Adventures, LLC, Rochester, MI (US)

(21) Appl. No.: 19/088,828

(22) Filed: Mar. 24, 2025

Related U.S. Application Data
(63) Continuation-in-part of application No. 16/262,397, filed on Jan. 30, 2019, now Pat. No. 12,262,086.
Application No. 16/262,397 is a continuation of application No. 14/384,973, filed on Sep. 12, 2014, now Pat. No. 10,231,019.
(60) Provisional application No. 61/611,357, filed on Mar. 15, 2012.

(51) Int. Cl. H04N 21/454; H04N 21/475

(52) U.S. Cl. CPC H04N 21/4542; H04N 21/4751

(57) ABSTRACT

A system and method of providing an artificial intelligence (AI) media agent for a digital content controller are provided. In one embodiment, the system or method includes receiving user inputs via a user interface of a digital content controller comprising respective levels of user-defined content filters for a plurality of content categories; using artificial intelligence to analyze each of a plurality of media content members of a library of media content to assign ratings for each of the plurality of content categories for each media content member of the library, wherein the operation of analyzing the library comprises using artificial intelligence to review each media content member to identify content ratings for each of the plurality of content categories and identify portions of content corresponding to the content ratings for each of the plurality of content categories; identifying objectionable portions of content based on the plurality of content ratings compared to the respective levels of user-defined content filters; and automatically building a dynamic library of content appropriate for respective levels of user-defined content filters, wherein the dynamic library comprises media content meeting the respective levels of user-defined content filters and media content configured to be altered during playback by removing or replacing one or more objectionable portions of content.

### CROSS-REFERENCE TO RELATED APPLICATIONS

This application is a continuation-in-part of based on and claims priority to U.S. patent application Ser. No. 16/262,397 filed on Jan. 30, 2019 entitled DIGITAL CONTENT CONTROLLER, which is a continuation application based on and that claims priority to U.S. patent application Ser. No. 14/384,973 filed on Sep. 12, 2014, which is based on and claims priority to PCT/US13/32216, filed on Mar. 15, 2013 entitled “DIGITAL PARENTAL CONTROLS INTERFACE” which is based on and claims priority to U.S. Provisional Patent Application No. 61/611,357, filed on Mar. 15, 2012 entitled “A DIGITAL PARENTAL CONTROLS INTERFACE THAT LIMITS MEDIA CONTENT RATED BY A NUMERICAL VALUE SYSTEM”, each of which is hereby incorporated by reference in its entirety.

### FIELD OF TECHNOLOGY

A system for providing a media artificial intelligence (AI) agent including content/parental controls of media content, and more particularly, a device, system and methodology of a media AI agent that allows content/parental control of specific undesired electronic content.

### BACKGROUND

As the demand for and level of digital content continues to expand in our society, our youth continue to be exposed to content by producers that parents do not want their children to see. Unfortunately the movie and other industries do not police themselves nor do they successfully keep harmful content from minors. The openness of the internet provides the ability of minors to have continuous access to inappropriate content. This continues to be a problem as parents often cannot police the streaming content into their homes due to the lack of advances in digital control technology.

The problem with uncontrolled digital content is not limited to just movies. Digital media covers many aspects of our society and includes not only movies, but also music and video games. None of this digital media employs a common filtering or rating system that can be used by parents or other adults that may wish to preclude inappropriate content from coming into their homes. Search engines and media players also have no way of knowing if the content is appropriate for the value systems of their customers, other than G, PG, R ratings. And even though a movie rating may be provided on some content, such as movies, the movie ratings do not offer enough rating detail for most families nor do they provide any filtering options. Nor do the ratings break down with particularity and inform a user as to what content has caused a rating to be rated R, PG, or other rating.

It is not uncommon for one scene in a movie or one word in a video game to be the only offensive aspect of the media content. The current parental control technology may either block all PG content or none of it. It doesn't allow the user to block part of the content, and it doesn't allow the user to block content for specific offensive content. Current parental control technology blocks entire web sites, even those that offer valuable content for students because of one article or word. They block entire movies or video games because of the rating, when users might not be offended.

It would be desirable to provide a tool, system and methodology to block specific offensive content such as, but not limited to, nudity and language, without blocking specific content such as violence. Such improved media system should be flexible, selectable and work simultaneously with movies, music, video games, and other electronic mediums and products.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent the illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1 illustrates a parental controls user interface, showing a scaled slide bar for allowing a person to control media content;

FIG. 2 illustrates a main user interface, showing what a user sees when logging into the Axiom TV web site;

FIG. 3 illustrates a screen shot of an administrative ratings user interface;

FIG. 4 illustrates a logic diagram of how the media manager module operates;

FIG. 5 illustrates a logic diagram of how the parental control user interface operates;

FIG. 6 illustrates a logic diagram of how the filtering system operates to extract undesirable content;

FIG. 7 illustrates a logic diagram of how the rating system operates;

FIG. 8 illustrates a logic diagram for a mobile content extraction routine module;

FIG. 9 illustrates a representative screen shot of a web site showing content that has not been extracted;

FIG. 10 illustrates a screen shot of the FIG. 9 web site after the content has been extracted using the FIG. 8 logic, but now showing preferred content; and

FIG. 11 illustrates a system including a network based platform to provide user interfaces of the present disclosure;

FIG. 12 illustrates a screen shot of a user interface of a media AI agent to set media content boundary levels for a digital content controller;

FIG. 13 illustrates a screen shot showing a user interface to identify AI determined micro-or sub-genres for a block/purge list;

FIG. 14 illustrates a screen shot showing a user interface to identify media content platforms;

FIG. 15 illustrates a screen shot showing a user interface to connect the media AI agent to a media platform;

FIG. 16 illustrates a screen shot showing a user interface for a user to manage one or more lists for the media AI agent;

FIG. 17 illustrates a screen shot showing a pull-down menu portion of a user interface providing list-related options for a user;

FIG. 18 illustrates a screen shot showing a pull-down menu portion of a user interface providing additional list-related options for a user;

FIG. 19 illustrates a screen shot showing a user interface configured to allow a user to play, rate, hype, or bookmark media content;

FIG. 20 illustrates a screen shot showing a user interface configured to allow a user to rate and review media content;

FIG. 21 illustrates a screen shot showing a user interface configured to allow a user to enter a review of media content;

FIG. 22 illustrates a screen shot showing a user interface configured to allow a user to manage one or more lists of media content;

FIG. 23 illustrates a screen shot showing a user interface configured to allow a user to post information to social media;

FIG. 24 illustrates a screen shot showing a user interface configured to allow a user to create an AI prompt for use by the media AI agent;

FIG. 25 illustrates a schematic diagram of an embodiment of a media AI agent system;

FIG. 26 illustrates a schematic diagram of an embodiment of a media AI agent system; and

FIG. 27 illustrates a schematic diagram of an embodiment of a media AI agent system.

### DETAILED DESCRIPTION

An exemplary embodiment of a parental controls system has an interface and provides a numeric rating to every media element in its content database for categories including, but not limited to, sex, language, violence, drugs, nudity and other parameters. The system then allows a user to set parental controls on each of these parameters. The system will automatically block all content that includes this content or removes the offensive elements from the content, so the user can experience media without offensive content.

Another embodiment provides a system that allows the user to have a single media player that can search and access digital movies, music, news and video games, blocking inappropriate content or even skipping inappropriate elements within the content.

Another embodiment of the system allows a user to be able to block specific offensive content such as nudity without blocking specific content such as violence. This media system will simultaneously work with movies, music, video games, and other content.

Another embodiment provides a media manager with a search engine and media player, wherein the search engine is improved to include the If-Then parameters of the parental controls system according to the user settings. The media player is modified with the ability to read and act on a timeline-based edit list with all potentially offensive material marked with “in” and “out” points on the timeline. The player is modified to replace the offensive content with transition content or no content that would offer a safe user experience without too much disruption to the consumption media.

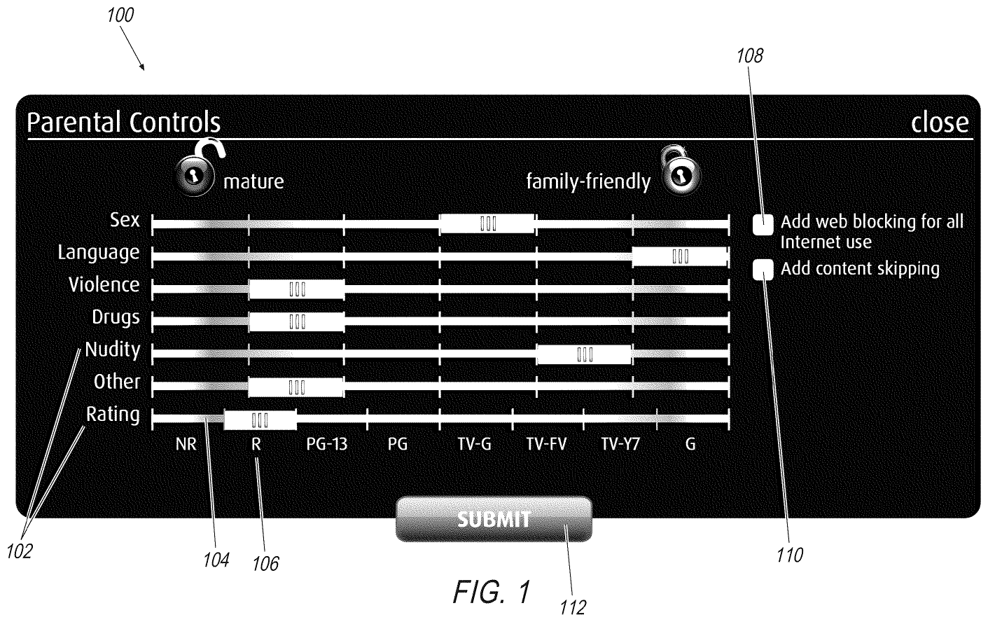

FIG. 1 depicts an exemplary screen shot of a parental controls user interface 100 that could be accessed via the internet page of a main user interface 200. This is the user interface a parent, guardian, or other may use which provides the ability to edit a filter for preferred search results. The parental controls user interface 100 is provided with a list of the multiple rating categories with a range from low to high, which could correlate to a mature to family-friendly scale. The rating filter can be used by many people including a parent, or for a linked user like a child, in order to establish different allowed results. The interface 100 includes rating categories 102 such as sex, language, violence, drugs, nudity, and others. A rating bar 104 is provided which can correlate to known rating categories 106 such a NR, R, PG-13, PG, TVG and more.

The user interface 100 also includes an add web blocking for all internet use tab 108, add ClearPlay to skip sex, vulgarity and violence on all of your DVD's tab 110, and a submit tab 112. The add web blocking tab 108 activates the system to use the filter on the content that is streaming from the internet. The add ClearPlay tab 108 permits a user to apply the desired filter on DVD products. Thus, the system 10 can be used to filter media content from multiple sources. It will be appreciated that the interface 100 may have other tabs and features.

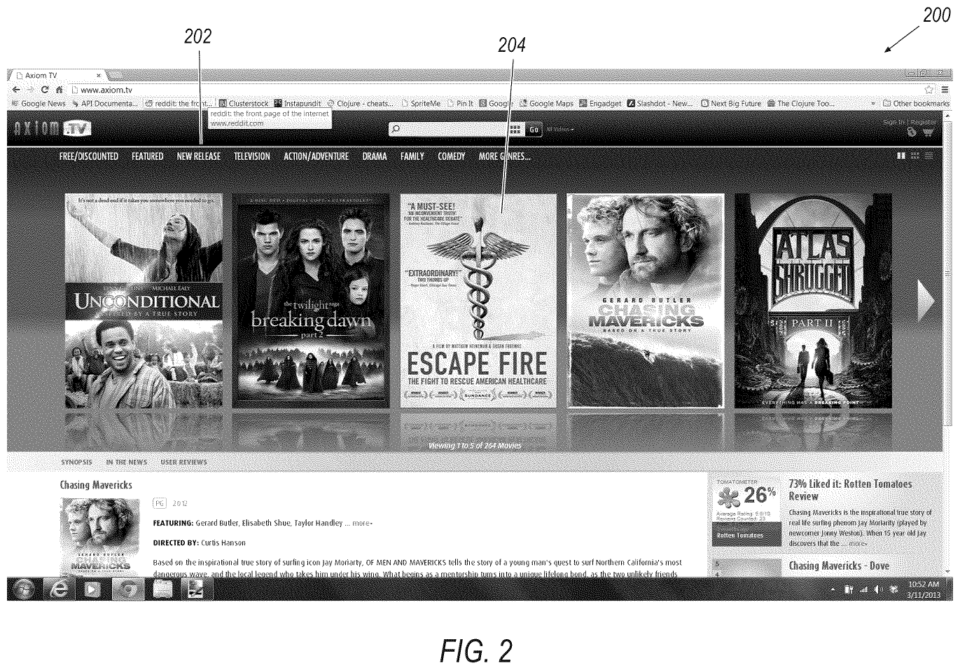

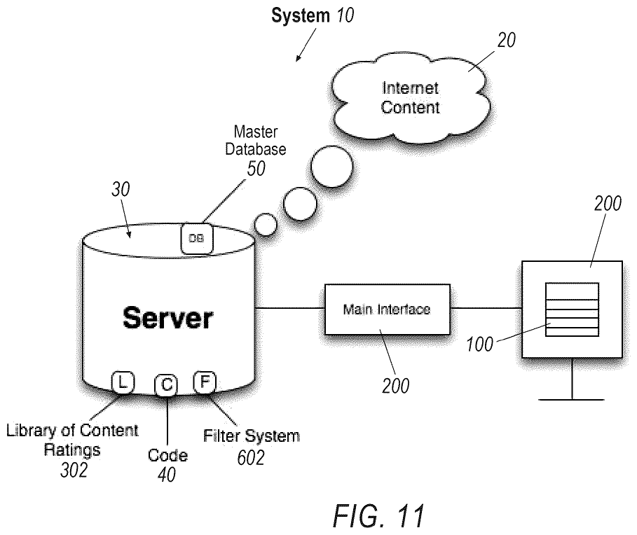

FIG. 2 depicts a main user interface 200 that is accessed via the internet by a user. This allows the system 10 to be accessed remotely and from anywhere as long as the internet 20 is available. The main user interface 200 can be on a network based platform and is the primary interface consumers drive through to access the system 10. See FIG. 11. A server 30 has a CPU and memory and hosts the program 40 which drives the system 10. The interface 200 includes categories 202 (FIG. 2) of content such as new releases, drama, family, and others, for the consumer to choose from. Thus, a library 204 of content can be built within the system 10 and saved on the server 30 or accessed via the internet 20.

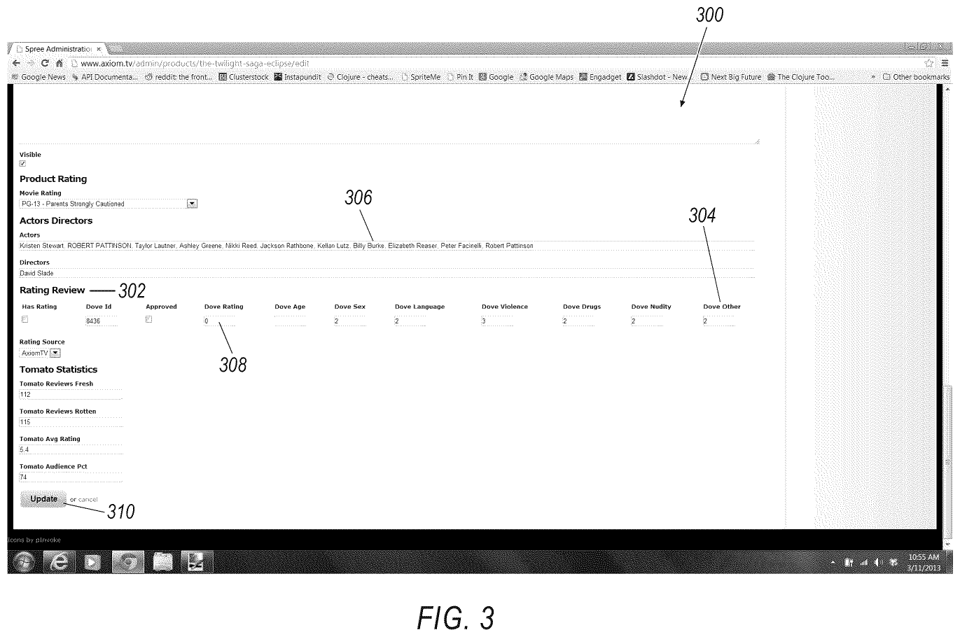

FIG. 3 illustrates a screen shot for the administrative ratings user interface 300. This is one of the screens a manager of the system 10 can access in order to help build a library of content ratings 302. See FIG. 11. This process could be done automatically by the system 10 by pulling the information from other sources and propagating the fields 308 that are seen in the interface 300. The library 302 may collect ratings from an existing provider 304 and build the library from pre-existing information. A manager of the system 10 may input other data 306 such as actor information, directors, movie rating, and more. Once the manager has propagated the fields 308, a submit button 310 is pressed to save the information to the server 30.

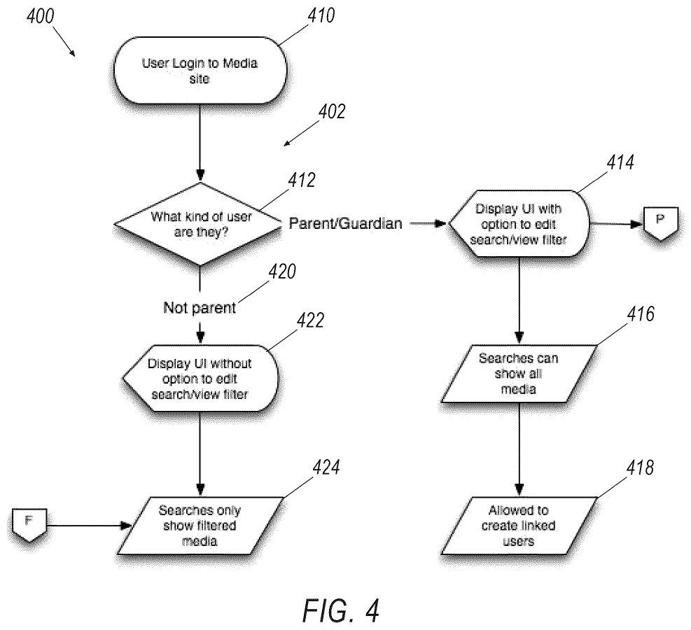

FIG. 4 illustrates a media manager module 400 and the algorithm or flow chart 402 that drives the decision making for this module. The media manager module 400 is a routine of the computer program 40 that operates on the server 30. The media manager 400 is accessed by entering through the main user interface 200 (FIG. 2). To access the media manager 400, the user logs into the site 410, and as part of the login process, the system 10 searches to see what kind of a user they are 412. If they are a parent or guardian, they are given an icon with an option to edit 414 the parental control settings for themselves, and for any users they are linked to. The user can then search to show all media 416 that passes through the filter. All displays of movies consist of a search (either the default search, or some typed in keywords) will only display results which fall within the parameters of the parental control setting. If a user is a parent or guardian, they are allowed to create user profiles for linked users 418. If a user is not a parent or guardian, they can't modify the search parental control filters, nor create linked users.

If the person that logs in is not a parent 420, then the system 10 will display a user interface without the option to edit a search or to view the filter 422. Under this method, the result of any searches will only show filtered media 424.

The media manager module 400 provides a system of searching and sorting media so that the user will find content throughout the digital universe. If content has a rating, the user will have access to the content, based on parental controls settings. If the content has no rating, the user will only have access if the ability to view non-rated content option is selected by the user.

The media manager module 400 acts as an optional search engine tool that allows the user to search for video, audio, text, images and interactive software (“Content”) using the Web, media appliance (TV, radio), mobile devices or other digital technology. The media manager and search engine could adopt and add the rating and filtering system to its function. A video editor feature is optional and presents a feature for editing content and delivering cleaned content, on demand. Content can be acquired from distributors with edits (made for TV or airline versions), and content can be edited by third-party content providers.

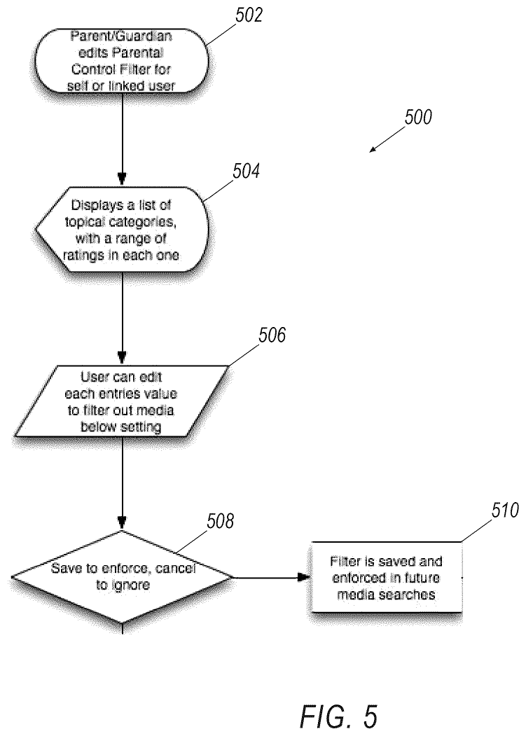

FIG. 5 illustrates a logic diagram 500 of the operation of the parental control user interface 100. The parental controls user interface 100 is depicted in FIG. 1 and is the feature that allows the user to manually set parameters of what he/she wants to have access to within his/her family or community. The user can set a numeric value to sex, language, violence, drugs, nudity or other potentially offensive content. The interface 100 becomes the input to a rating system that could be used with other search engines or media managers that already exist if the parental controls are applied with or without a user interface.

The logic diagram 500 for the parental control user interface includes the exemplary step of providing a parent editing a filter 502, displaying a list of topical categories, with a range of ratings in each one 504, allowing the user to edit each entries value to filter out media below the setting 506, saving to enforce, cancel or ignore the setting 508, and if saved is selected, then saving to the system the filter to enforce in future media searches 510. It will be appreciated that this algorithm can be modified to enhance performance of the system 10.

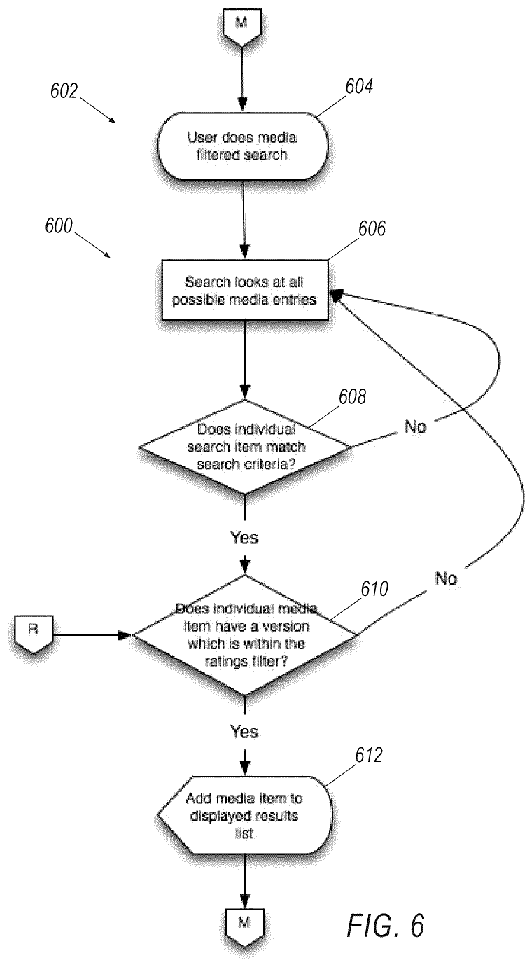

FIG. 6. Illustrates a logic diagram 600 that is a module within the code 40 that is stored on the server 30, or even in the cloud. This logic forms the filtering system 602 and sets out the process of filtering content. This is the logic behind the scenes that interfaces with the inputs by a consumer at interface 100. Any searching by a user of the media database will use the associated rating filter system 600 to constrain the results. The setting on a particular category will limit any subsequent search to be lower or equal to the rating that the specified filter. Setting the filter to the highest settings will allow all media entries to be displayed.

The filter system 602 includes the following process steps. First it starts with the user does a media filtered search 604. Then the search looks at all possible media entries 606. Next it asks does individual search item match search criteria 608. If not, then the routine goes back to step 606. If yes, then the process advances to determining does the individual media item have a version which is within the ratings filter 610. If no, then the process reverts to step 606. If yes, then the process adds media item to displayed results list 612.

The filtering system 602 compares the user settings from the parental controls user interface 100 with the rating system 702 for the content. If the numeric value of the content is within the parameters of what the user wants to allow, the content will be accessible to the user. If the numeric value of the content is within the parameters allowed by the user, the content will be accessible to the user in part or in whole, based on the user settings.

The rating system logic diagram 700 includes the step of a media item gets added 704 to the master database 50. Next decision of are these sources for rating this media item is asked 706. If the answer is no, then the media item is added as an unrated item to a list 708. If the answer to the question “are these sources for rating this media item” is yes, then the rating system combines multiple rating sources into a rating list 710. Thereafter a master list of media is updated 712.

The rating system 702 provides for all media entities loaded into the master database 50 (see FIG. 11) can have a rating assigned to it. If a media entity doesn't have one, it is unrated, which is treated as the highest possible rating. When a media entry is added to the database, ratings can be assigned to it both programmatically (from external rating sources like MPAA, IMDB, and Dove) and edited and reviewed by a system administrator editor. The ratings are organized into multiple categories (like sex, violence, drugs, etc.) that can range from low to high.

The rating system 702 is maintained in the database associated with all content presented to the user. The rating system 702 includes all known public rating systems such as the MPAA, TV and video game ratings as well as a custom database for each of the parameters set in the parental controls user interface. Other database sharing is used from sources such as the Dove Foundation as well as manually entered ratings from users and technology developers as well as artificial intelligence to detect offensive content in order to get complete content ratings.

The rating system 702 provides the data to the filtering system 602 so that the parental controls settings can be applied to give access or denial to part of the content or all of the Content. The rating system 702 is helpful because without a common rating system on each parameter of sex, language, violence, drugs, nudity or other, the system would have no basis of filtering. This rating system is applied to the content as a whole. This rating is also applied to individual chunks of content as well. Without filtering the rating system 702 will not block content for the user.

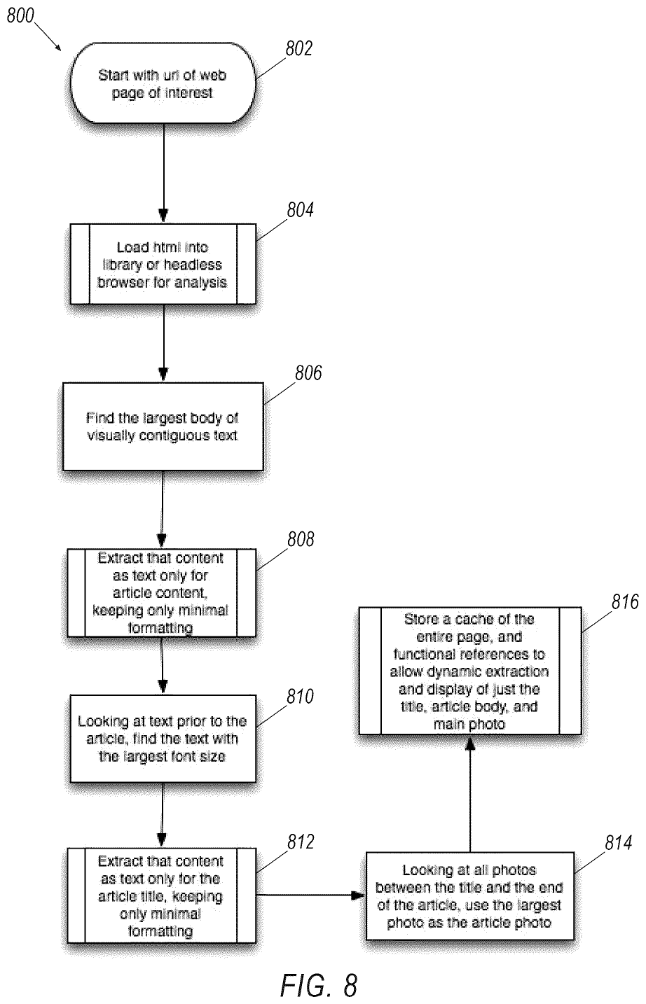

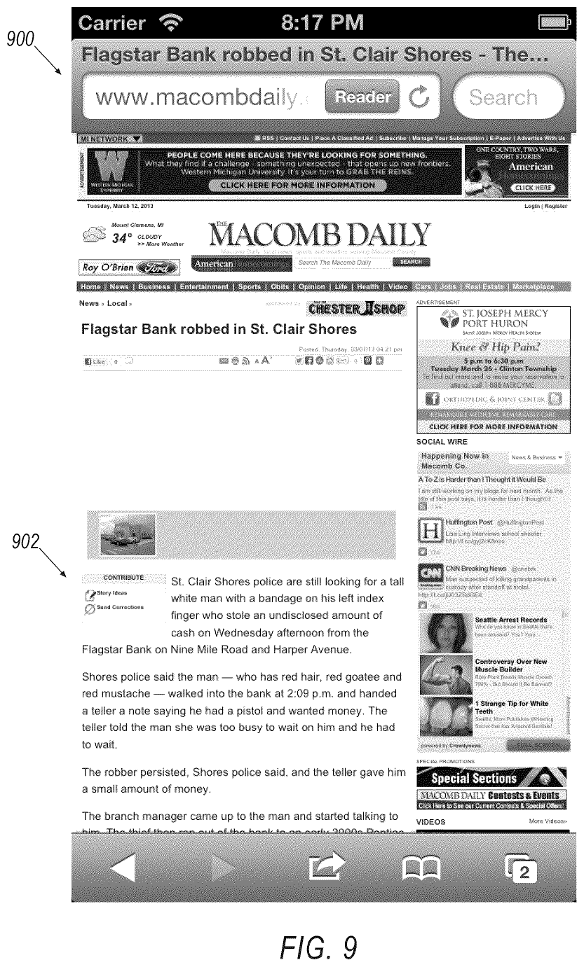

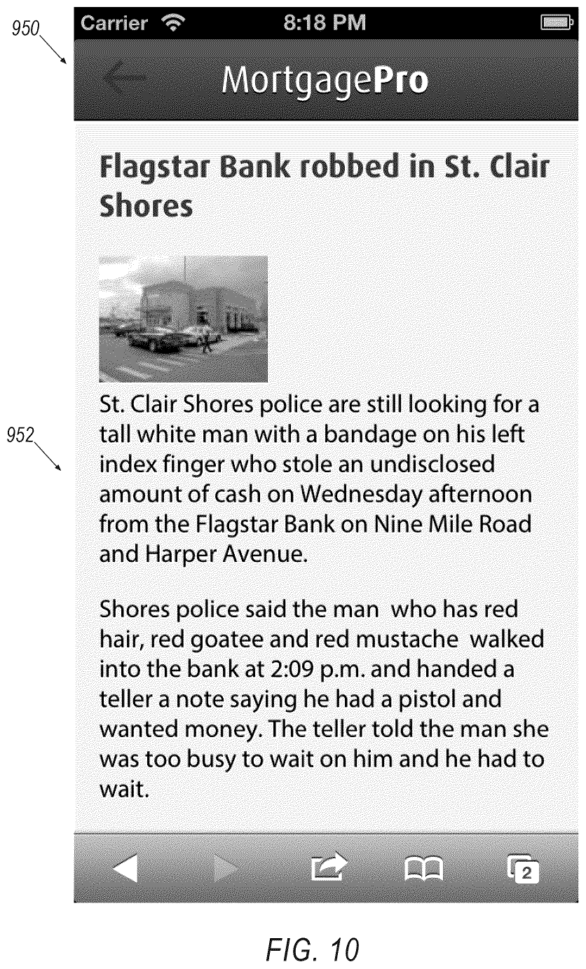

FIG. 8 illustrates a logic diagram 800 for another module of the system called a mobile content extraction routine 802. The function of this module or routine is to take the essence of a web page article 900 (see sample at FIG. 9), and display only the most salient pieces of information with a consistent user interface for better readability and faster article navigation (see 950 sample at FIG. 10). The most salient pieces of information are the article title, its textual content, and one article photo if there is one. The extraction is performed on a given web page url of interest. A headless browser and/or html analysis library is used to be able to programmatically view and analyze the page. The main body of the article is obtained by finding the largest body of visually contiguous text on the page. Standard library routines are used to find and extract textual only contents plus minimal formatting like bold and italics. Text is considered visually contiguous if they are next to each other in the page display without separation by too much space (an experimentally obtained parameter) or any borders. Next, the title is obtained by finding the text element above the article that has the largest font size. Finally the article photo is obtained (if there is one) by grabbing the largest photo anywhere in the html between the title and the end of the article body. The entire page is stored in the database, along with functional extraction references to the previous pieces. The purpose of that being to be a better article viewer of articles, and not store an edited version of the article which have copyright issues.

With continued reference to FIG. 8, the logic diagram 800 starts with a URL of a web page of interest 802. Next html is loaded into a library of headless browser for analysis 804. Next the system finds the largest body of visually contiguous text 806. Then it extracts that content as text only for article content, keeping only minimal formatting 808. Next it looks at the text prior to the article, and finds the text with the largest font size 810. Then it extracts that content as text only for the article title, keeping only minimal formatting 812. Next it looks at all photos between the title and the end of the article, and uses the largest photo as the article photo 814. And finally, the system 10 stores a cache of the entire page, functional references to allow dynamic extraction and display of just the title, article body, and main photo 814.

FIG. 9 illustrates a representative screen shot 900 of a web site showing content that has not been extracted. The extraction process 802 as shown in FIG. 8 is implemented which results in a scrubbed or cleaned web page. FIG. 9 shows a web site 950 after it has been scrubbed 952. The preferred content is now shown.

All of the above components of the disclosure work individually and together to perform a unique function for an integrated media system with dual-function parental controls (both on the Content and within the Content itself). If the user searches for media content including but not limited to video, music, text, images or interactive software, find all possible matches, but don't make any visible yet to the consumer. If content has no rating and user has parental controls are off, then give the user access to content and make it visible. If the user has parental controls turned on, then filter content, blocking all non-rated content first. If the content has a rating, then filter content according to user settings. If the user has a setting to block content rated 3 or higher for a particular offensive element (such as nudity) and content contains material with a rating of 4 for the same offensive category, then the system blocks the content.

If the Content is segmented into rated content chunks, then only block the chunks of content that are offensive, allowing other content to become accessible and visible. For example, if one scene in a video game presents a nude woman and if the user has settings to block all nudity, only that scene would be removed from the game. However, if the content is not segmented into rated content chunks, block the content in its entirety. If filtering is complete, then the system makes visible and available to the user any content that passes the parental controls filters, and blocks all other content from any access.

The above steps and system 10 may be modified and yet remain within the spirit of the embodiments shown. The present system is a digital application which is developed to create a search engine which operates on an internet-based platform. It could use, but is not limited to, use of a combination of HTML and Javascript database technology, with web servers and high bandwidth Internet. The search engine is able to proactively crawl the Web and create a database that is responsive to users when they come to search for media they want to consume. However, the exemplary search engine will include a highly filtered and user managed database of media that will be ranked and rated on parameters for parental controls. The system 10 will allow users and system managers to input ratings on the content database.

For example, a movie such as “Facing the Giants” is rated with 5 stars from the Dove Foundation. The Dove Foundation gave this movie a “0” rating for sex, drugs, nudity and other, but it got a “1” rating for language and violence. The search engine is operable to pick up this rating from the Dove Foundation and store the rating for this movie in a database. Under this scenario, the filter should only show “Facing the Giants” as a search result if the user sets parental controls at a “1” or higher for language and violence. Thus, the system 10 is flexible in that it lets the user to specifically set parental control ratings for different categories, search the web for content that meets that criteria, and then allow the acceptable content to pass through the filter to a consumer.

The system 10 also provides a video editor that can customize video according to user preferences. In the case of “Facing the Giants,” the users will be given the option to edit the movie for their personal consumption. They will be given the option to create a mark in and out points for each of the offensive language instances or violent scenes. The edited versions will be resubmitted to a source for rating. After rating with edits, the source will provide back an “edited” version of the ratings. If the “edited” rating for “Facing the Giants” gives it “0s” on all parameters, all users will have access to it. When the user plays this content with parental controls all set at “0,” the edit list from the user who created it will be downloaded with the full movie, and the playback works according to the user edits.

A method of operation will now be described. It will be appreciated that this is but one exemplary embodiment and that other are contemplated. First, a user would access the Media Manager through a media device such as a TV set device, a mobile device, a PC or other digital system. The user would set up the parental controls user interface settings by selecting a numeric value for sex, language, violence, drugs, nudity and other individual settings.

Next, the user would search for media. The media manager will only present media that can be experienced without any of the inappropriate content blocked within the parental controls user interface. The user will play, read, view or otherwise experience the media that has been filtered or edited by the media manager. Seamless to the user, the system will allow the user to experience content without seeing any content defined as offensive by the user. In some cases the content will be blocked in its entirety, but in others the system will edit or present an edited version of the content in such a way to remove offensive material from content that previously had offensive material in its original state.

Additionally, the user will have the option to rate or edit content for the greater community of users. For example, the user will be given the option to upload and submit a rating or apply for a rating from the community or from an approved third-party rating system for content provided by the user.

The user will also be given the opportunity to mark specific chunks of content as inappropriate based on a numeric value on sex, language, violence, drugs, nudity or other parameters to be set by the user. The user will be given the ability to edit the content and share their edits with the community. The edited content will be submitted to be rated as new content for the filtering system. The user will have the ability to share ratings, parental control settings and edited material with social media and within the media manager user community. Additionally, this rating system and parental control technology could be used as an improvement on a search engine or media player of any kind.

The system 10 could produce a rating database for content. The system 10 could also produce an edit list or a library of content that has been edited for inappropriate material. The system 10 could also produce a search engine technology that is superior to others in getting personalized results. The system 10 could produce media content.

### Media Artificial Intelligence (AI) Agent

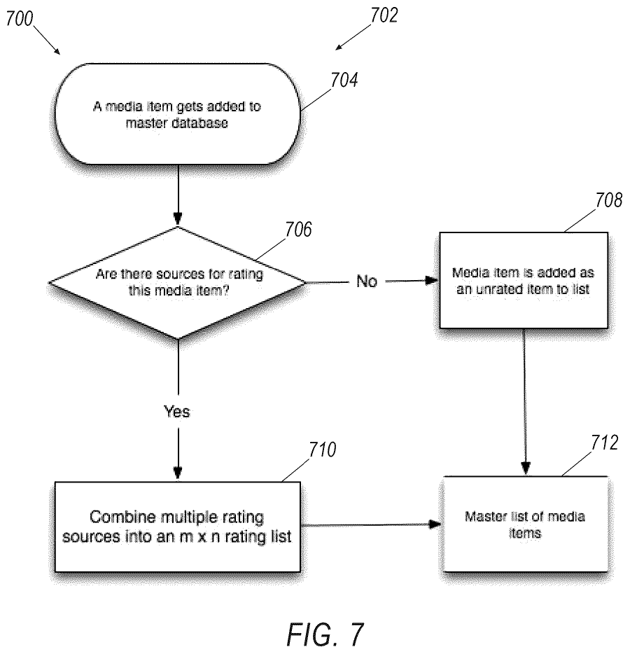

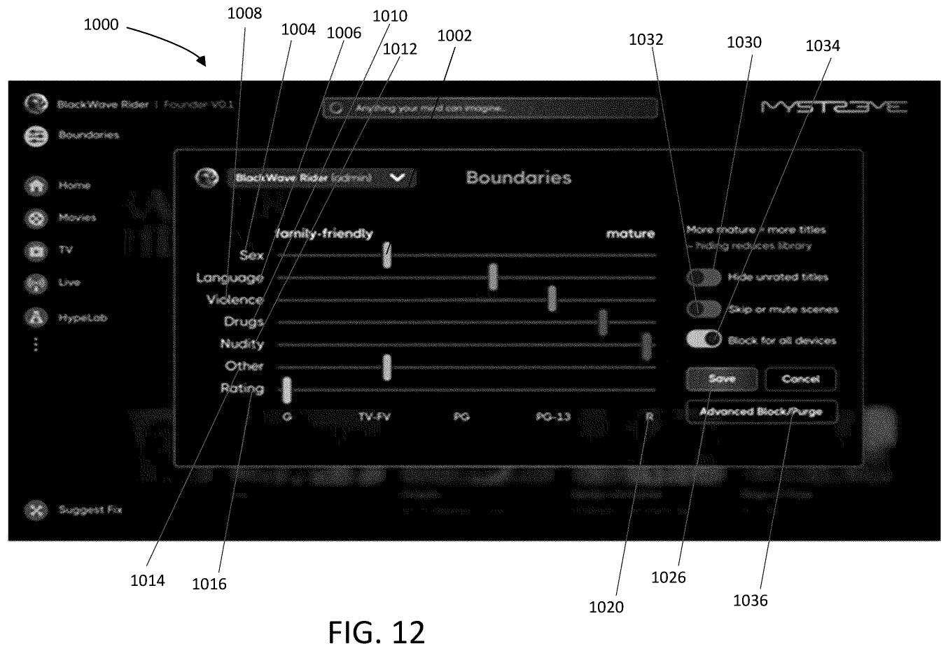

FIGS. 12-24 show an example embodiment of an artificial intelligence (AI) media agent configured for use with a digital content controller, such as but not limited to the digital content controller shown in FIGS. 1-11. The media AI agent is configured to operate on behalf of one or more individual user based at least in part on a plurality of content category settings selected by the user. As described above with respect to FIGS. 1-11, the plurality of content category settings may include, but are not limited to, sex, language, violence, drugs, nudity and other parameters. The system allows the user to set controls (e.g., parental controls) on each of these parameters.

In this embodiment, the AI media agent is configured to aggregate, curate and filter media content based on the selected content category settings for a user. The AI media agent is also configured to create block lists and/or whitelists of the media content based at least in part on the content category settings and/or user actions.

An example embodiment of a parental controls system has an interface and provides a numeric rating to every media element in its content database for the plurality of content categories including, but not limited to, sex, language, violence, drugs, nudity and other parameters. The system can automatically block all media content that includes one or more individually objectionable content category or removes the offensive elements from the media content that include one or more objectionable content category, so the user can experience media without offensive content.

Another embodiment provides a system that allows the user to have a single media player that can search and access digital movies, music, news and video games, blocking inappropriate content or even skipping inappropriate elements within the content.

Another embodiment of the system allows a user to be able to block specific offensive content such as nudity without blocking specific content such as violence. This media system will simultaneously work with movies, music, video games, and other content.

Another embodiment provides a media manager with a search engine and media player, wherein the search engine is improved to include the If-Then parameters of the parental controls system according to the user settings. The media player is modified with the ability to read and act on a timeline-based edit list with all potentially offensive material marked with “in” and “out” points on the timeline. The player is modified to replace the offensive content with transition content or no content that would offer a safe user experience without too much disruption to the consumption media.

In one embodiment, for example, the media AI agent is configured to review media content and/or metadata (such as summary information, close captioning, or the like) using artificial intelligence to identify portions of the media content that are applicable to one or more individual content categories that may be filtered on behalf of an end user. The media AI agent, for example, may scan or otherwise review video content to identify potentially offensive content by identifying one or more items that characterize one or more of the content categories. An identification of a cigarette or liquor bottle, for example, may be applicable to a content category and the media AI agent may take actions such as the following: (1) identify a numeric or other rating within a range of ratings for the identified content, (2) identify a start and stop timing indicator for one or more scenes with such potentially offensive content such that the media content may be altered during playback (e.g., skipping or replacing potentially offensive content); and (3) identify a screen location during the duration defined by the start and stop indicators that may be altered to delete or obscure the potentially offensive content material (e.g., replace a liquor bottle with a water bottle). The media AI agent may identify the rating based on an accumulation of potentially offensive content, by a level of offensiveness of the content (e.g., liquor versus illicit drugs), or the like. The media AI agent may also scan for other content categories, such as nudity or sex by automatically identifying skin tones in excess of other scenes within the content.

Where the rating information is determined to be within a user identified level of acceptable content filters, the media content may be played without alteration. Where the rating information is greater than the user-identified acceptable content filter ratings, the potentially offensive content may be altered during playback in order to provide a media content viewing experience in accordance with the user-identified acceptable content filter ratings.

Embodiments of the media AI agent are further configured to enable a user to provide a multitude of other settings and content that may also be used to train the AI media agent beyond merely the user-identified acceptable filter content ratings. The media AI agent can provide the user the ability to provide block/purge lists to remove content from a dynamic library suitable to be played for the user and to provide whitelists/Hypelists to maintain content within the dynamic library suitable to be played for the user.

The media AI agent can also provide the opportunity to rate media content, share media content and/or their ratings to others and further use that as data to train an AI model for curating content for that particular user's dynamic library.

The media AI agent can also provide the user with an AI prompt to search for or identify new content for inclusion and/or exclusion from the user's dynamic library.

The user's shared lists, lists of others shared with the user, and even social media activity may further be used within an AI model to train the media AI agent in curation of content for the user's dynamic library.

FIG. 12 shows an example parental controls user interface 1000, showing a plurality of scaled slide bars 1002 for allowing a user to control media content according to a plurality of individual content categories 1004, 1006, 1008, 1010, 1012, 1014, 1016 applicable to the media content. In this embodiment, for example, the user interface 1000 includes media content categories for sex 1004, language 1006, violence 1008, drugs 1010, nudity 1012, other 1014, and ratings 1016 categories. Each category includes a sliding bar 1002 ranging across a scale including a plurality of selection levels ranging from family-friendly to mature. In various embodiments, for example, each category may include discrete levels 1020, such as levels from 1-5, 1-10, from one rating (e.g., G) to another rating (e.g., R). The plurality of sliding bars 1002 allows a user to select individual levels of control for each of the plurality of media content categories. Thus, a user may select a level of control for each category according to his or her own comfort level with respect to the individual media content category. As shown on the user interface 1000, the more restrictions that are selected (e.g., the more the selected settings are set closer to the family-friendly level of control), the number of media content titles is reduced as a portion of the overall media content fails to satisfy the selected levels of control.

FIG. 12 also shows a user-selection pull-down menu 1024 for selecting between a plurality of users or groups of users (e.g., administrator, parent(s), child(ren), student(s), employee(s), visitor(s), etc.) that allows the user to select different settings for different users or groups of users. In this manner, a parent or other administrator may select different settings for different users or groups of users. The parent, for example, may select different settings for parents, adult children, teens, and younger children. A business or other organization, such as a school, may select different settings for different groups of users, such as teachers and students or employees and visitors. The user may select an individual or group of users via the pull-down menu, select individual settings for that individual or group of users via the plurality of slider bars 1002, save the selections via a save button 1026, and move on to another individual or group of users to repeat the process via the pull-down menu 1024.

In this embodiment, the user interface also includes option selectors for the following:
Hide unrated titles 1030
Skip or mute scenes 1032
Block for all devices 1034

In this example, the selector for “Hide unrated titles” 1030 allows a user to block titles that do not have a rating (e.g., an MPAA or other rating) that may be selected via the sliding bar for ratings.

The selector for “Skip or mute scenes” 1032 allows a user to select for media content to be played with objectionable content portions skipped or muted depending on the selected levels for the media content categories. Objectionable language, for example, may be amenable to muting, while objectionable video, such as sex, nudity, or violence may be skipped during playback or other content may be played in its place (alternate audio (e.g., dubbed language) or video content (e.g., a replacement scene)).

The user interface also includes a “Block for all devices” selector 1034 that allows the user to block content for all devices accessing the media content via the AI media agent (e.g., via an access point such as a router or WiFi access point). In this manner, one or more setting selections may be applied across all devices. The media content may be blocked at the access point or may be blocked or filtered at the user device.

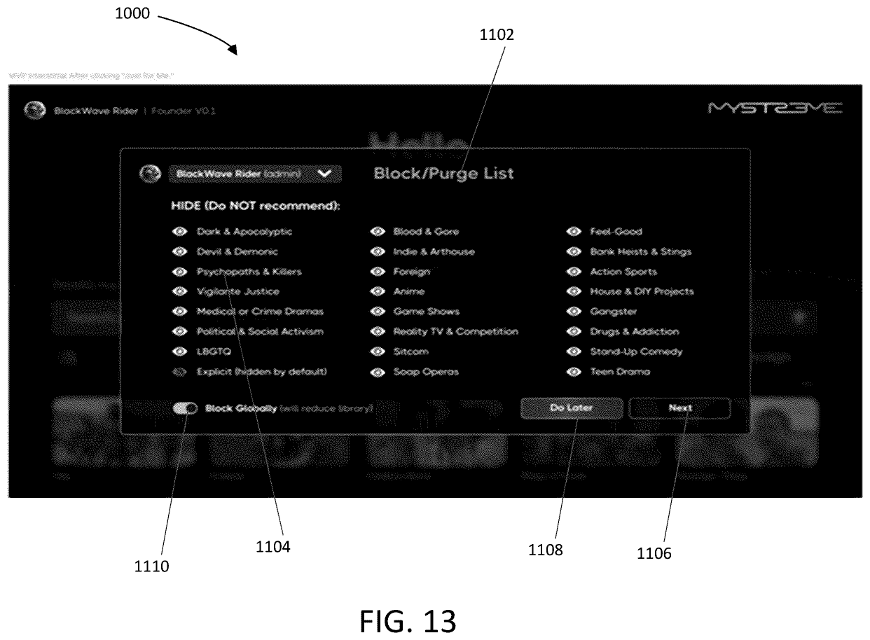

An Advanced Block/Purge icon 1036 links to a series of multi-step forms configured to create one or more block list or purge list such as shown in FIG. 13 below and/or to create one or more whitelist, which may be referred to as a “Hypelist” in various embodiments.

The user interface 1000 further includes a menu panel 1040 shown on the left side of the user interface in this example. The menu panel 1040 may be a perpetual panel (e.g., banner or side panel) that is configured to expand into a scrolling list of genres and Hypelists/whitelists.

The HypeLab options 1042 is provided to allow a user to access a HypeLab configured to create one or more Hypelists/whitelists. Selecting the triple ellipsis can expand the panel of the user interface to provide additional options.

In one embodiment, the system is configured to link to one or more streaming apps or services, such as Netflix, Amazon, or the like. The AI media agent is configured to seamlessly interact with these apps or services and can access (e.g., log in via stored credentials), transact (e.g., purchase content automatically via stored user payment information), aggregate content (e.g., search, scrape, identify and access content relevant to a user's library), curate content, categorize content, rate content, and evaluate content using the user selectable settings (e.g., average or otherwise analyze third party ratings information as applicable to the user's selected content setting selections described above such as via MPAA, IMDB, Dove, and other ratings sources).

In one embodiment, the AI media agent is configured to be trained on a combination of user generated data (e.g., reviews, block/purge lists, white lists), data shared with or from one or more other users, AI curated media content and user interaction with that AI curated media content (e.g., did the user view the suggested content, rate the suggested content, etc.).

Media content may thus be eliminated from inclusion in a user-selectable media library based on the user's customizable media content category setting selections made via the user interface of FIG. 12.

Based on the aggregation, evaluation, and curation, the system is further configured to provide filtering of media content that includes one or more objectionable content category. By providing “safe” filtered content, the system is configured to expand the user-accessible library of media content that meets the user-customizable media content category setting selections.

The filtering operation may be configured to skip or remove objectionable media content or replace objectionable media content with alternative media content that complies with the user-customizable media content category settings selections. In one embodiment, for example, the system may identify, and store start and end locations (via a database) within the media content for each potentially objectionable portion of the media content according to potential user-selectable media content category settings. In this manner, the system can access these locations to use in an active filtering of the content during playback, such as skipping the portions of the media content and/or replacing the portions.

In one embodiment, a subset of media content available to a user has been or is available to be filtered. As discussed above, this can supplement the media library that satisfies user-customizable settings that restrict one or more media content category. Over time, the AI media agent is configured to scan additional media content (e.g., via an AI large language model or AI neural network) to identify potentially objectional content, store corresponding markers identify that potentially objectionable content, and later use the stored markers to filter the newly identified content for playback depending on the user selected settings.

FIG. 13 shows another view 1100 of a user interface 1000 including Block/Purge List generation tool 1102. In this example, the tool 1102 lists a plurality of micro-genres 1104 that may be AI determined via the AI media agent from the media content itself, from metadata, and/or from third-party ratings or reviews. In one embodiment, for example, the AI media agent is configured to use keywords and content analysis to identify one or more micro-genres 1104 that may be inappropriate for one or more audiences. The micro-genres, for example, may be created from AI review of the media itself, pre-assigned, identified via user input, or the like. The AI creation of an unlimited number of potential micro-genres provides increased flexibility and adaptability of the system in curating content for users.

In the example shown in FIG. 13, for example, the user interface identifies a plurality of micro-genres 1104 that may be assigned to a block/purge list. Alternatively, one or more micro-genres may be assigned to a Hypelist/whitelist. The user interface provides the user the ability to select one or more of the identified micro-genres to apply to a block/purge list as shown. The user may, for example, select “Dark & Apocalyptic” as inappropriate for children users of the system, and the AI media agent is configured to remove and/or filter the media content associated with the selected micro-genre(s) from the media content available for one or more users of the system.

Once the user has selected or not selected one or more of the micro-genres 1104 from the list, the user may select the Next icon 1106 to proceed to further options to generate a block/purge list. The user may also select “Do Later” icon 1108 and the AI media agent may be configured to save the selections for later review and application.

The user interface 1100 shown in FIG. 13 also includes a “Block Globally” selector 1110 that allows the user to choose one or more of the micro-genres to block across the system and remove those selected micro-genres from the library of available media content that may be played via the system via one or more access points associated with the particular user.

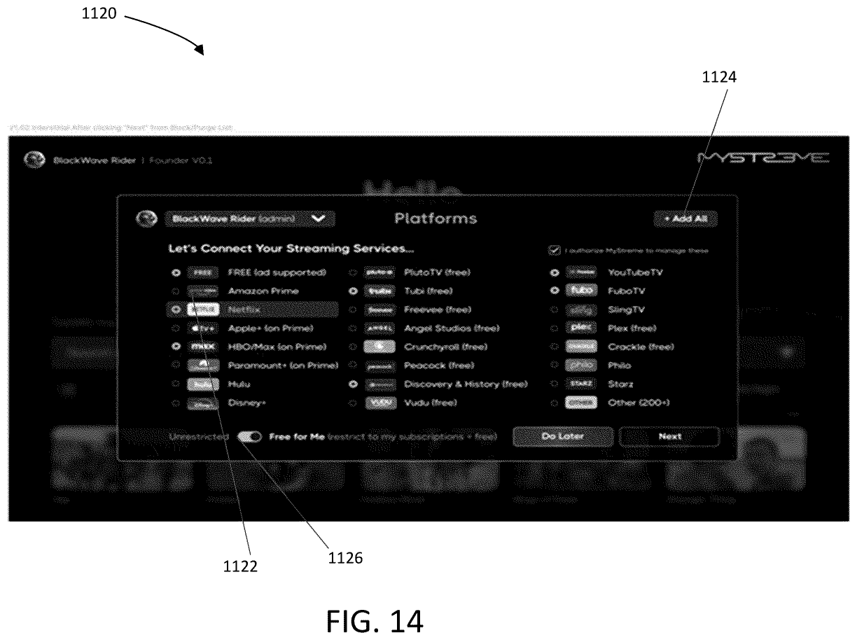

FIG. 14 shows another view 1120 of the user interface 1100 configured to create or edit a block/purge list. In this embodiment, the user interface 1000 provides a selection of possible streaming service platforms 1122 that may be available to one or more users. In this example, the user interface allows the user to select from freely available Internet services (e.g., ad supported services) and subscription services (e.g., Netflix, Apple+, Amazon prime, etc.) that the user can select from. The user interface also includes an “Add All” option 1124 to automatically select all of the available options and a “Free for Me” selector 1126 that limits the selection to the user's already existing subscriptions and free services.

The AI media agent can be configured to store user credential information 1128 to automatically access the services on the user's behalf and to store user payment information to transact with one or more services on the user's behalf (e.g., automatically purchase or rent media content selected from the library of available media content matching the user-selected media content category settings). The AI media agent system may provide an authorized budget (e.g., monthly) for which selections may be automatically authorized for the agent to transact directly with the third-party service provider.

In one embodiment, for example, the AI media agent includes one or more browser extensions that enable the AI media agent to automatically interact with one or more third party on the user's behalf to make the media content available as a portion of the user's media library accessible via the Ai media agent system. Different browser extensions, for example, may provide log in credentials, payment information, or other information that enable the AI media agent to operate as if the AI media agent was the user accessing the third-party media services.

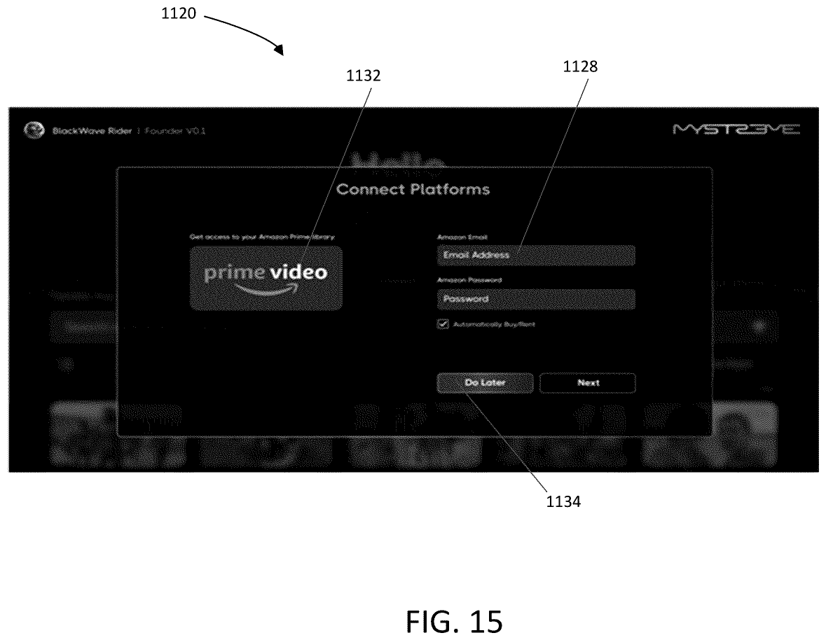

FIG. 15 shows a view 1130 of the user interface 1000 where the AI media agent allows the user to connect to a third party streaming service provider 1132, such as Prime Video in this example, by providing the AI media agent credentials 1128 (e.g., email address and password). The user interface also provides a selector 1134 through which the user may select the option to automatically buy/rent media content from this provider.

Once completed, the AI media agent is configured to link the third-party account to the user's AI media agent account. Once completed, the user interface may revert to a prior page, such as the block/purge list tool.

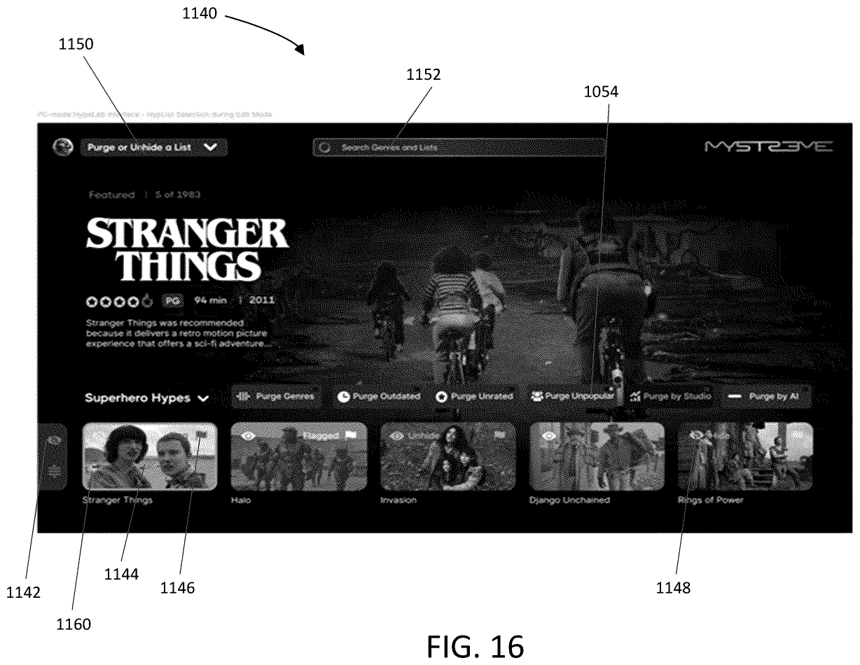

FIG. 16 shows another view 1140 of the user interface 1000 through which the user may edit features available with a block/purge list. In this example, the user interface identifies a plurality of media content titles 1142 that are hidden or flagged for inclusion in the block/purge list within the tool. The user is given the option to hide/flag or unhide/unflag titles or lists for inclusion in or exclusion from the block/purge list. As shown in FIG. 16, the titles/lists 1142 already flagged are identified by a thumbnail image 1144 for the title/list showing a flag icon 1046 indicating that the title/list has been flagged. Similarly hidden titles/lists are identified by a thumbnail image showing a hidden icon 1148 indicating that the title/list has been hidden.

The user may select the title/list and edit the flag or hidden categorization for the title/list.

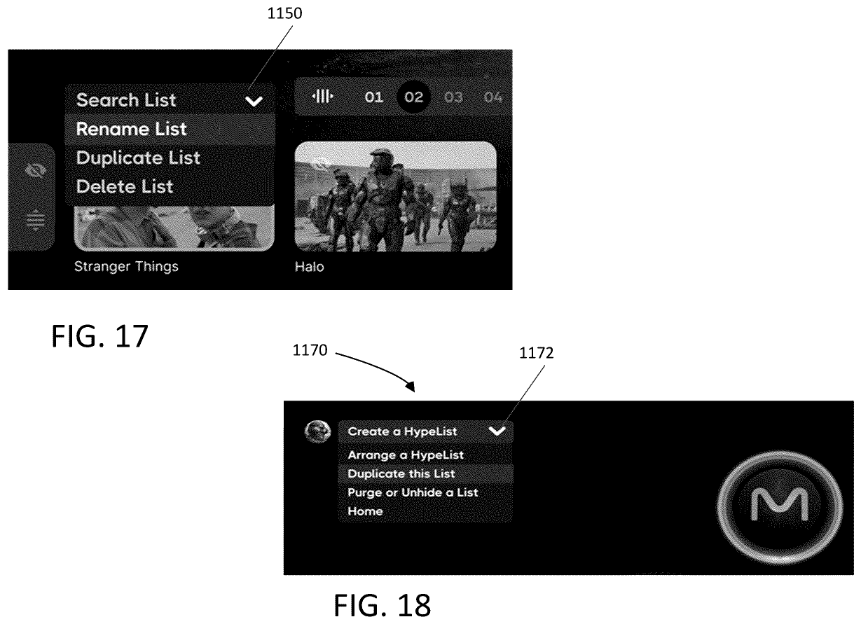

The user interface 1140 shown in FIG. 16 also includes hide/unhide and flag/unflag controls. These controls include a Tag Dropdown selector 1150 that allow a user to Search a Hypelist, Duplicate a List, Duplicate a List, Delete a List, and Rename a List (see FIG. 17).

FIG. 16 also shows a Search window 1152 configured to allow a user to search from a list of titles. This Search window, for example, may allow a parent or other administrator to search from a complete listing of titles potentially available or may provide a search limited to a restricted list of titles that satisfy the parent or administrator user-customizable media content category settings for a child or other restricted user.

The user interface further includes an Unhide Title/List on each hidden title/list and a Hide icon on each public title. The icons allow the user to unhide or hide individual titles or lists of titles. An Unhide Row icon allows the user to unhide an entire row of titles/lists.

An unhide/flag mode enables a user to perform a high volume of individual hiding and flagging of media content. In a purge or unhide list mode, each title includes an icon (e.g., an eye icon) on the thumbnail or other designator of a title/list. The flag, in one example, reads “Flagged” when both hidden and flagged. The flag icon may be missing if hidden but not flagged. Icons may be shown as a partial opacity (e.g., 50% opacity) and white when not hidden or flagged.

The user interface may also include “Tiny Toggle” icons on each button. The Tiny Toggle “pin light” on each button indicates whether the button/algorithm has already been activated on this Block/Purge list or Hypelist/whitelist or not. The Purge buttons 1154 on the example of FIG. 16, for example, include Purge Genres, Global Purge, Purge Outdated, Purge Unrated, Purge Unpopular, Purge by Studio, and Purge by AI. In this example, the Purge Genres button activates a pop-up interstitial of the list of genres (see, e.g., FIG. 13) and related keywords to be removed from or added to this list based on the “Just for Me” interstitial.

The Global Purge button may be available for one or more genres and/or micro-genres, individually.

The Purge Outdated selector allows the user to set by date (e.g., before or after a last release date).

The Purge Unrated removes all titles/lists not rated (e.g., NR) and/or below a certain predetermined or a selected rating (e.g., 0, 1, or 2 stars out of 5 stars).

The Purge Unpopular selector allows the user to remove all titles not meeting a predetermined or user selected criteria (e.g., remove all titles not in the top 2000 titles rated on IMDB).

The Purge by Studio selector allows the user to add all titles/lists to a block/purge list by studio and/or add all titles/lists to a Hypelist/whitelist by studio by leaving the selector unchecked. If any studio on a whitelist offers a title, the title may remain available even if it is offered by a blocked studio.

The Purge by AI selector is configured to activate an AI prompt window and provides an automated AI prompt to purge content (e.g., on a repeating basis, such as daily, weekly, monthly, etc.). The AI prompt may be used to remove (or add) media content that does not fit the user's preferences or parameters set for a particular list.

It should be understood that where examples describe options for adding or removing media content to or from a block/purge list, those options may be similarly used to add or remove media content to or from a Hypelist/whitelist, or vice versa.

FIG. 16 also shows a name tag dropdown (shown as “Superhero Hypes”) 1160. When the user selects the drop-down menu, other Hypelists or Block/Purge lists are shown. The current list may be saved when the user selects another list, and the user is able to edit the newly selected list. Alternatively, a search bar may be used to search for a genre or list.

Hypelists/whitelists may be created and edited and provide for parental controls and/or personal preferences via the Hypelists/whitelists. The Hypelists may be created in a “Hypelab.” The Hypelists may include user-defined and shareable lists. The users can set up their parental or other restrictive controls based on following lists created by others, who they trust, such as friends and family. User profiling can be integrated and keywords associated with the Hypelists, and a series of keywords can be used to define the Hypelists recommended based on a series of keywords (e.g., selected by the user from a cloud of keywords and titles. The Hypelists can alternate with the most recent Hype from the user and/or on a periodic or repeating basis.

FIG. 18 shows a HypeLab user interface 1170 configured to allow a user to create and/or modify a Hypelist/whitelist. A drop-down menu 1172, or other selector, allows the user to “Create a Hypelist,” “Arrange a Hypelist,” “Duplicate this List,” “Purge or Unhide a List,” and “Home,” which hides the menu and presents the final product of the edits on a Home Screen.

The Duplicate this List option allows the user to copy and name the copy to create a new list. Other options link to a HypeLab mode for editing a list and/or provide a panel of genres to select from.

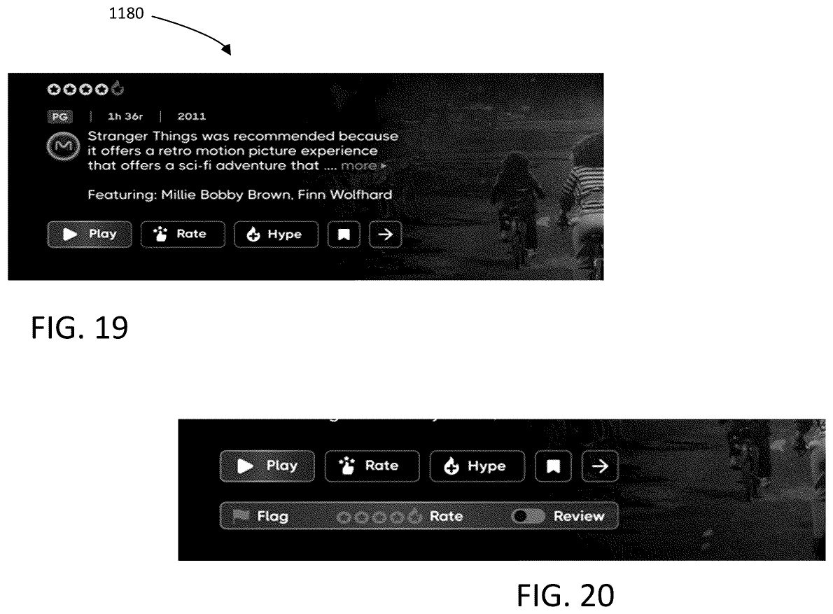

FIG. 19 shows another user interface 1180 in which a suggested title is presented for potential inclusion in a list. The user interface includes a rating of 1 to 5 stars, an explanation for why the title was suggested, and options for playing the title, rating the title, Hyping the title, bookmarking the title, and a right arrow option to open additional options, such as additional playback options (e.g., by streaming service, such as Netflix, Apple+, and Disney+).

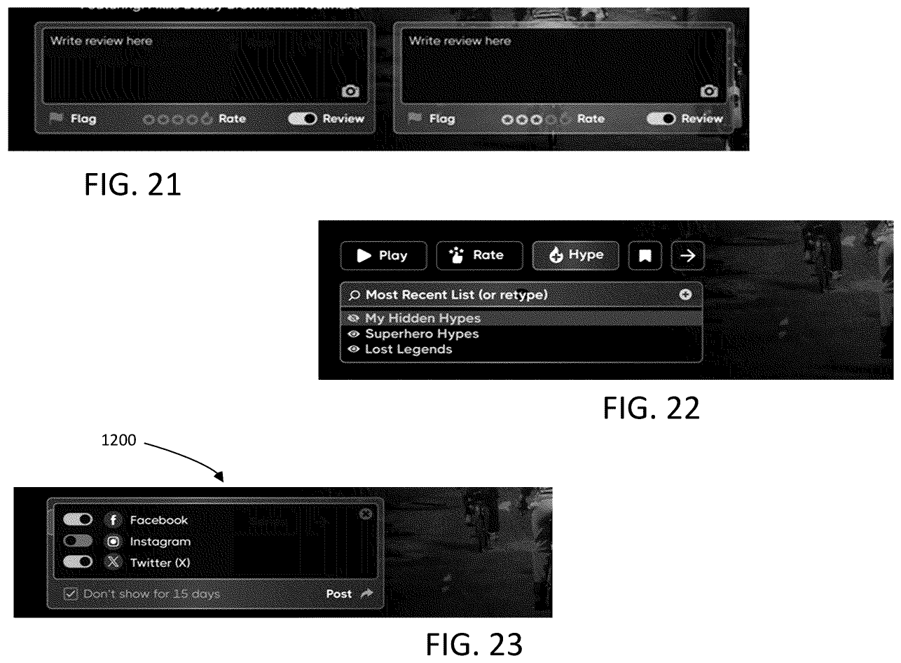

The user may rate the title by clicking on the stars in the upper left corner, or by clicking the rate button. The user may flag the title (e.g., mark as explicit) or review the title in which a pop-up panel is provided for a text, photo or video upload (see, FIGS. 20 and 21).

A list of hidden/private or public/visible Hypelist tags are searchable and may be indicated, such as by the eye/blocked eye icons shown in FIG. 22. A new list can be created, such as by selecting a (+) symbol at the right of the search bar or pull-down menu.

FIG. 23 shows an example user interface 1200 configured to allow a user to share a Hypelist or a review via social media.

As titles on the Hypelist have been viewed, the watched titles may be automatically identified as “Seen,” and the user has the option to automatically remove the title from recommendations and/or from the Hypelist.

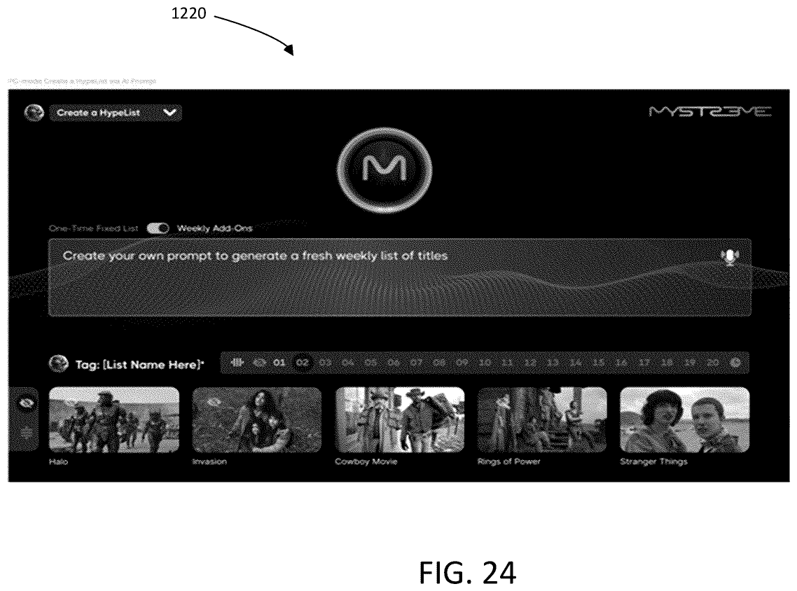

FIG. 24 shows a user interface 1220 for the AI media agent including an AI prompt 1022 for a user. The AI prompt 1022 allows the user to enter an AI prompt for the AI media agent to generate a list of media content.

The AI prompt 1022 may be used to generate a Hypelist, add content to an existing Hypelist, or add content for a Block/Purge list. In one embodiment, the AI prompt 1022 can be used to generate a recurring new list (e.g., weekly, monthly) for a particular Hypelist based on the AI prompt. After the AI media agent generates an algorithm based on the AI prompt 1022, the AI media agent can apply the algorithm to a data set including media content (e.g., a large language model “LLM”) to generate a list of media content. The list of media content may be recommended for viewing and/or used to generate a new list or added to an existing list.

Once the AI generated content is added to a new or existing list, the list may be edited, such as described above with respect to the HypeLab and/or content hidden or flagged to be removed from the list and/or added to a block/purge list.

User edits to the AI generated content to or from lists can be further used by the AI media agent for future application. Activity of the user, such as watching the content, rating the content, hiding the content or removing the content from a list by the user may be used by the AI media agent as an input to train an AI model (e.g., LLM) for future interactions with the user. Where the user hides or flags content as inappropriate, for example, the AI media agent may generate categories, genres, micro-genres, keywords, or the like to train or adjust the algorithm applied to the model.

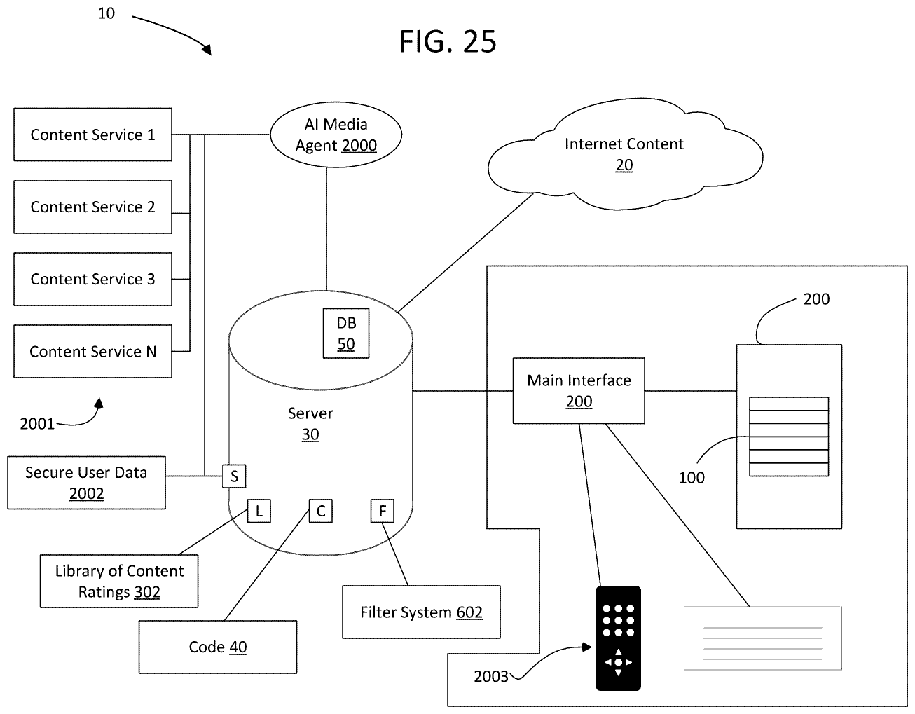

FIG. 25 is a schematic diagram of an example system of an AI media agent 2000 for a digital content controller. In this embodiment, a system 10 includes a server connected to an Internet connection to access Internet content 20 and a plurality of content services (Content Service 1, Content Service 2, Content Service 3, . . . , Content Service N). The server hosts a user interface 200 that is accessed via the internet by a user. The user, for example, may access the user interface 200 via a browser 100 or other interface on a user client device. The client user device, for example, may include a wireless remote control, voice commands, a keyboard, computer, tablet, smart television, and/or another user client device.

Inputs received from the user device are received by the server via the user interface 200, interpreted by AI and activated by the AI media agent 2000. The system 10 is configured to be accessed remotely and from anywhere as long as the internet connection is available. The main user interface 200 can be on a network-based platform and is the primary interface consumers drive through to access the system 10. A server 30 has a CPU and memory and hosts a program 40 which drives the system 10. The interface 200 receives inputs, such as those shown in FIGS. 12-24 to enable the user to access the AI media agent 2000. The AI media agent 2000 is configured to operate on behalf of one or more individual user based on a plurality of content category settings selected by the user. The plurality of content category settings may include, but are not limited to, sex, language, violence, drugs, nudity and other parameters. The system allows the user to set controls (e.g., parental controls) on each of these parameters.

The AI media agent 2000 is configured to aggregate, curate and filter media content based on the selected content category settings for a user. The AI media agent 2000 is also configured to create block lists and/or whitelists of the media content based at least in part on the content category settings.

A library 204 of content can be built within the system 10 and saved on the server 30 or accessed via the internet 20. In one embodiment, the library includes media content from third party streaming services 2001 including Content Service 1, Content Service 2, Content Service 3, . . . , Content Service N.

The AI media agent 2000 is configured to scrape and save public content data from third party platforms 2001 and rating and ranking content via algorithms driven by the users of the digital content controller.

The AI agent 2000 is configured to save user credentials, such as passwords and log in information, to enable the agent to access services on behalf of the user and to save user financial data, such as credit card or other payment information, to allow the agent to transact (e.g., purchase or rent content) from the services on behalf of the user. The AI agent may be authorized by the user to act as an agent of the user, such as via a limited power of attorney, to be able to access the services on his or her behalf.

An ADA compliant interface remote control device 2003, such as used by disabled, children, or elderly users, may be used to power the AI media agent 2000 to navigate Internet pages, including third party services, as the AI media agent on behalf of the user. The ADA compliant remote-control device 2003 may work with one or more browser extensions to allow the AI media agent 2000 to access any needed services.

In the embodiment of FIG. 25, the AI media agent 2000, the server 30, database 50 are located on and accessible via the Internet, such as hosted via a cloud service provider. The Main interface 200, comprises a router, set-top box, smart television, computer, tablet or other computing device. The main interface 200 is located on a user's local service (e.g., home Internet service). In one embodiment, for example, the user interface 100 comprises a browser or application on user client device that accesses the AI media agent service via a local Internet access point (e.g., router).

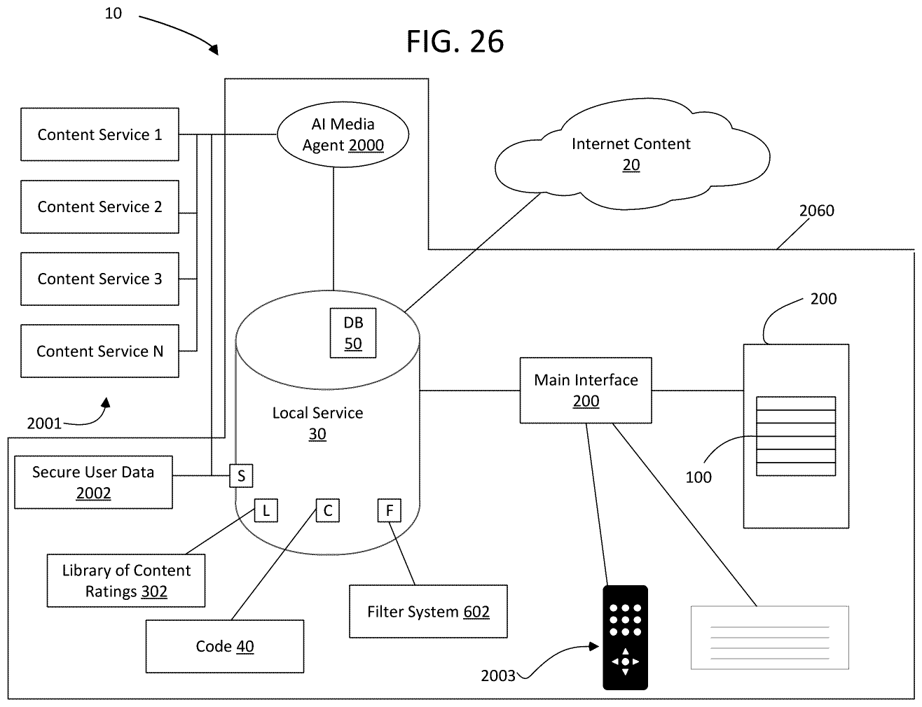

FIG. 26 is a schematic diagram of another example system of an AI media agent 2000 for a digital content controller in which the AI media agent 2000 comprises an edge computing system 2050. In this embodiment, the edge computing system 2050 resides on a local client network (or other network such as a cloud network) that is under the direct control of an end user and comprises a local AI media agent that is configured to perform operations of the AI media agent locally on a client controlled network. The AI media agent 2000; media aggregating, curating, and filtering service 30, main interface 200, and client computing device all reside on a client local network 2060. The service is configured to access media content from one or more of a plurality of media content services (Content Service 1, Content Service 2, Content Service 3, . . . , Content Service N) and other Internet media content via the Internet. Processing operations are performed locally, such as via an edge processing device located on the user local network. The edge processing device may include AI chips or chipsets. AI chips are specialized computer chips designed to handle AI tasks quickly and efficiently. Types of AI chips include GPUs, FPGAs, ASICs, and NPUs, each with unique features. Key functions of AI chips include parallel processing, energy efficiency, customization, and real-time data processing. Examples of AI chips include several of those produced by NVDIA. The AI chips of the edge processing device are configured to perform the AI media agent operations described herein.

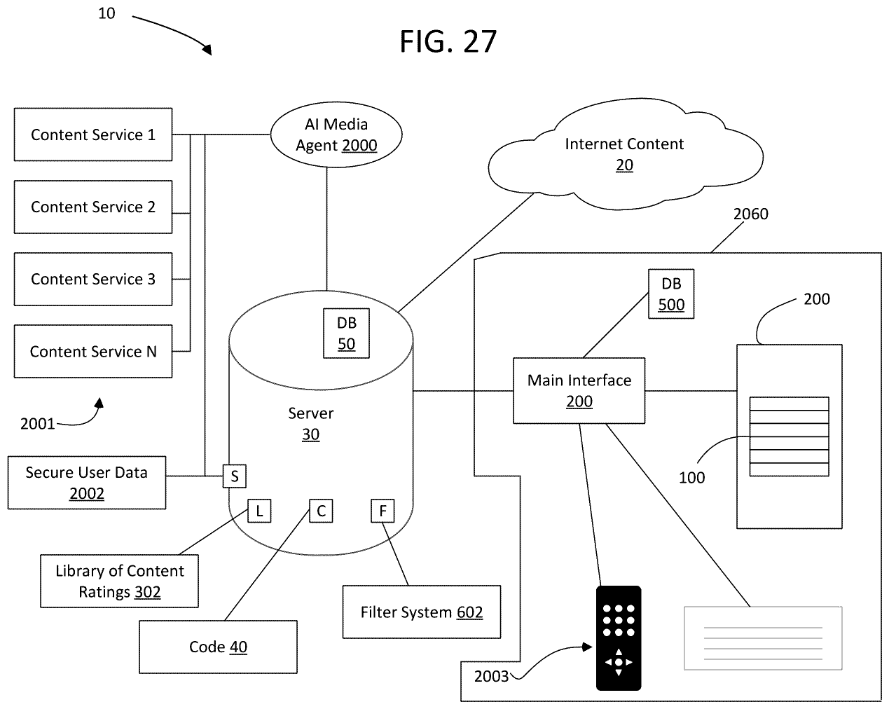

FIG. 27 is a schematic diagram of yet another example system of an AI media agent 2000 for a digital content controller in which the AI media agent 2000 comprises a hybrid system of the systems shown in FIGS. 25 and 26. In this embodiment, the AI media agent 2000, Server 30 are located on the Internet and perform the aggregating and curating operations via the Internet. The Internet-based AI media agent also identifies filter locations for individual media content within a media collection. The client main interface comprises hardware and software located at the client local network (e.g., on an Internet access point such as a router, on a set top box, a smart television, a client computer or the like). The client main interface is configured to perform media playback, with filtering, locally. Filtered media playback may be performed as described above using time locators for objectionable content. The locators may be saved in the remote database 50 or in a local database 500.

In one embodiment, a method of providing an artificial intelligence (AI) media agent for a digital content controller is provided. In this embodiment, the method includes receiving user inputs via a user interface of a digital content controller comprising respective levels of user-defined content filters for a plurality of content categories; using artificial intelligence to analyze each of a plurality of media content members of a library of media content to assign ratings for each of the plurality of content categories for each media content member of the library, wherein the operation of analyzing the library comprises using artificial intelligence to review each media content member to identify content ratings for each of the plurality of content categories and identify portions of content corresponding to the content ratings for each of the plurality of content categories; identifying objectionable portions of content based on the plurality of content ratings compared to the respective levels of user-defined content filters; and automatically building a dynamic library of content appropriate for respective levels of user-defined content filters, wherein the dynamic library comprises media content meeting the respective levels of user-defined content filters and media content configured to be altered during playback by removing or replacing one or more objectionable portions of content.

The method can provide a user interface for the user to define a block list of content. The block list may further include one or more sub-genre of content (e.g., a micro-genre determined using artificial intelligence analysis of media content and/or metadata associated with the media content).

The method can further include providing curated media content specifically tailored to the user based at least in part on the respective levels of content category filters and the block list.

The method can also provide a user interface for the user to define a whitelist of content. The whitelist may further include one or more sub-genre of content (e.g., a micro-genre determined using artificial intelligence analysis of media content and/or metadata associated with the media content).

The method can further include providing curated media content specifically tailored to the user based at least in part on the respective levels of content category filters and the whitelist.

In another embodiment, the media content configured to be altered is altered during playback on a network (e.g., a local network or cloud network) that is under the control of the user.

In one embodiment, the AI media agent is instantiated on an edge AI processing network located on a network (e.g., within a local network or cloud network) that is under control of the user.

In another embodiment, a media artificial (AI) agent for a digital content controller is provided. In this embodiment, the media AI agent provides a user interface with a program in communication with the AI media agent. The media AI agent comprises an AI processor to receive user inputs via a user interface of a digital content controller comprising respective levels of user-defined content filters for a plurality of content categories. The media AI agent is also configured to cause the media AI agent to use artificial intelligence to analyze each of a plurality of media content members of a library of media content to assign ratings for each of the plurality of content categories for each media content member of the library. The operation of analyzing the library comprises using artificial intelligence to review each media content member to identify content ratings for each of the plurality of content categories and identify portions of content corresponding to the content ratings for each of the plurality of content categories. The media AI agent causes the AI agent to identify objectionable portions of content based on the plurality of content ratings compared to the respective levels of user-defined content filters. The media AI agent is also configured to automatically build a dynamic library of content appropriate for respective levels of user-defined content filters, wherein the dynamic library comprises media content meeting the respective levels of user-defined content filters and media content configured to be altered during playback by removing or replacing one or more objectionable portions of content.

The media AI agent can provide a user interface for the user to define a block list of content. The block list may further include one or more sub-genre of content (e.g., a micro-genre determined using artificial intelligence analysis of media content and/or metadata associated with the media content).

The media AI agent can further include providing curated media content specifically tailored to the user based at least in part on the respective levels of content category filters and the block list.

The media AI agent can also provide a user interface for the user to define a whitelist of content. The whitelist may further include one or more sub-genre of content (e.g., a micro-genre determined using artificial intelligence analysis of media content and/or metadata associated with the media content).

The media AI agent can further include providing curated media content specifically tailored to the user based at least in part on the respective levels of content category filters and the whitelist.

In another embodiment, the media content configured to be altered is altered during playback on a network (e.g., a local network or cloud network) that is under the control of the user.

In one embodiment, the AI media agent is instantiated on an edge AI processing network located on a network (e.g., within a local network or cloud network) that is under control of the user.

It will be appreciated that the aforementioned methods, systems and devices may be modified to have some components and steps removed, or may have additional components and steps added, all of which are deemed to be within the spirit of the present disclosure. Even though the present disclosure has been described in detail with reference to specific embodiments, it will be appreciated that the various modification and changes can be made to these embodiments without departing from the scope of the present disclosure as set forth in the claims. The specification and the drawings are to be regarded as an illustrative thought instead of merely restrictive thought.

1. A method of providing an artificial intelligence (AI) media agent for a digital content controller comprising:
receiving user inputs via a user interface of a digital content controller comprising respective levels of user-defined content filters for a plurality of content categories;
using artificial intelligence to analyze each of a plurality of media content members of a library of media content to assign ratings for each of the plurality of content categories for each media content member of the library, wherein the operation of analyzing the library comprises using artificial intelligence to review each media content member to identify content ratings for each of the plurality of content categories and identify portions of content corresponding to the content ratings for each of the plurality of content categories;
identifying objectionable portions of content based on the plurality of content ratings compared to the respective levels of user-defined content filters; and
automatically building a dynamic library of content appropriate for respective levels of user-defined content filters, wherein the dynamic library comprises media content meeting the respective levels of user-defined content filters and media content configured to be altered during playback by removing or replacing one or more objectionable portions of content.

2. The method of claim 1, wherein the AI media agent provides a user interface for the user to define a block list of media content.

3. The method of claim 2, wherein the block list includes a sub-genre identification of content.

4. The method of claim 3, wherein the sub-genre identification of content is determined via artificial intelligence review of at least one of the media content and metadata associated with the media content.

5. The method of claim 2, wherein the AI media agent provides curated media content based at least in part on the block list.

6. The method of claim 1, wherein the AI media agent provides a user interface for the user to define a whitelist of media content.

7. The method of claim 6, wherein the whitelist includes a sub-genre identification of content determined via artificial intelligence review of at least one of the media content and metadata associated with the media content.

8. The method of claim 6, wherein the AI media agent provides curated media content based at least in part on the whitelist.

9. The method of claim 1, wherein the media content configured to be altered is altered during playback on a local network or cloud network under the control of the user.

10. The method of claim 9, wherein AI media agent is instantiated on an edge AI processing network located within a local network or cloud network under control of the user.

11. A media artificial (AI) agent for a digital content controller comprising:
a user interface device with a program in communication with the AI media agent comprising an AI processor to receive user inputs via a user interface of a digital content controller comprising respective levels of user-defined content filters for a plurality of content categories;
cause the AI media agent to use artificial intelligence to analyze each of a plurality of media content members of a library of media content to assign ratings for each of the plurality of content categories for each media content member of the library, wherein the operation of analyzing the library comprises using artificial intelligence to review each media content member to identify content ratings for each of the plurality of content categories and identify portions of content corresponding to the content ratings for each of the plurality of content categories;
cause the AI agent to identify objectionable portions of content based on the plurality of content ratings compared to the respective levels of user-defined content filters;
cause the AI agent to automatically build a dynamic library of content appropriate for respective levels of user-defined content filters, wherein the dynamic library comprises media content meeting the respective levels of user-defined content filters and media content configured to be altered during playback by removing or replacing one or more objectionable portions of content.

12. The media AI agent of claim 11, wherein the AI media agent provides a user interface for the user to define a block list of media content.

13. The media AI agent of claim 12, wherein the block list includes a sub-genre identification of content.

14. The media AI agent of claim 13, wherein the sub-genre identification of content is determined via artificial intelligence review of at least one of the media content and metadata associated with the media content.

15. The media AI agent of claim 12, wherein the AI media agent provides curated media content based at least in part on the block list.

16. The media AI agent of claim 11, wherein the AI media agent provides a user interface for the user to define a whitelist of media content.

17. The media AI agent of claim 16, wherein the whitelist includes a sub-genre identification of content determined via artificial intelligence review of at least one of the media content and metadata associated with the media content.

18. The media AI agent of claim 16, wherein the AI media agent provides curated media content based at least in part on the whitelist.

19. The media AI agent of claim 11, wherein the media content configured to be altered is altered during playback on a local network or cloud network under the control of the user.

20. The media AI agent of claim 19, wherein AI media agent is instantiated on an edge AI processing network located within a local network or cloud network under control of the user.
